(19) United States
(12) Patent Application Publication
(10) Pub. No.: US 2008/0127621 A1
(43) Pub. Date: Jun. 5, 2008

(54) Combined weed whacker, blower and vacuum apparatus

(75) Inventors: Peter J. Bovo, Columbus, NJ (US); Karen M. Bovo, Columbus, NJ (US)

Correspondence Address: Charles I. Brodsky, 2 Bucks Lane, Marlboro, NJ, 07746, US

(73) Assignee: Whack-Vac Enterprises, LLC

(21) Appl. No.: 12/011,144

(22) Filed: Jan. 25, 2008

Related U.S. Application Data
(63) Continuation-in-part of application No. 11/502,109, filed on Aug. 11, 2006, now abandoned.
(60) Provisional application No. 60/781,562, filed on Mar. 13, 2006.

(51) Int. Cl. A01D 34/90; A01D 43/063; A01D 87/10

(52) U.S. Cl. 56/12.9; 56/13.3; 56/13.7

(57) ABSTRACT

A housing which encloses the trimmer of a combined weed whacker, blower and vacuum to prevent grass, leaves and weeds from dispersal once cut, so as to capture them after a trimming action by recessing the trimmer substantially wholly within the enclosure to limit their dropping to the ground and so they can easily be vacuumed into a container bag.

### CROSS-REFERENCE TO RELATED APPLICATIONS

This application is a Continuation-In-Part of application Ser. No. 11/502,109 filed Aug. 11, 2006. A Provisional Patent Application covering the invention described herein was filed Mar. 13, 2006, and assigned Ser. No. 60/781,562.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to portable, hand-holdable trimmer devices for lawn and garden use, in general, and to a hand-holdable trimmer device which combines the functions of trimming, vacuuming and blowing in a configuration attractive for use about swimming pool areas, in particular.

2. Description of the Related Art

As is well known and understood, “grass” is a simple plant which will take over an area once a good environment is created for it. Unmown, grass grows a few feet tall, blooms in the late summer, and spreads its seeds in the autumn, to sprout in the spring. As is additionally known, grass also sends out runners which sprout new plants. As most grasses are perennial, they come back from year to year—although some do actually die of old age, needing to be reseeded every few years. Seeding, furthermore, is a fast way to grow new grass plants.

As generally accepted, the annoyance of having to hand cut grass in unmowable areas led to the development of the Weed Whacker in 1971—and from there, the many different types of weed trimmers on the market today. In deciding which one to purchase, three factors are generally considered: 1) power—making certain that the trimmer is powerful enough to handle the toughest job; 2) size—a trimmer having an adjustable neck so that it will fit the shortest and tallest of users; and 3) price—what can be reasonably spent in choosing the best trimmer for one's purposes and needs. Whether a buyer goes forward in purchasing a gas operated trimmer or an electric one, these same considerations of “power”, “size” and “price” come into play in the purchase of leaf blowers.

Electric leaf blowers, cordless electric leaf blowers, gas-powered blowers and gas-powered backpack blowers are also recognized as one of the green thumb user's most powerful tools. While gas-powered blowers are the more powerful unit, the electric ones are quieter. Mixing oil and gasoline operates the gas-powered leaf blower, while 2-stroke gasoline engines generally use the power backpack blower. In electric-powered leaf blowers, an electric motor drives the fan, so that these blowers require an electrical power source provided from an electrical outlet through an extension cord. For smaller lawn areas, the rechargeable battery operated unit can be used, in accordance with the limited operating time available. The air volume each type of all these blowers puts out needs to be checked for its ability to do the job at hand.

As will be appreciated, the hand held leaf blowers are the most popular among homeowners, mainly because of convenience and portable size; the backpack leaf blowers are used more often by professionals, and are mostly gas-powered; the backpack leaf blowers are typically used, and are most suitable for, larger areas. Wheeled or walk-behind leaf blowers are accepted as the best for maintaining large areas, and are preferred by professional and commercial users.

As will be understood, several models of leaf blowers are designed to operate in reverse, vacuuming leaves into a bag rather than blowing them away.

U.S. Pat. No. 5,862,595, on the other hand, describes a hand-holdable trimmer which incorporates a vacuum system for collecting the trimmer cuttings of grass into a convenient collection container mounted on the apparatus. In doing so, the disclosure describes that when using grass or weed trimmers, the cuttings are usually dispersed over a relatively wide area because of the high rotation speed of the filament head. As the disclosure sets out, it would be extremely advantageous if a grass or weed trimmer also incorporated means for sucking up the grass cuttings immediately after they were produced by the cutting head, and for storing the cuttings in a container carried with the trimmer. The patent asserts the elimination of the extra step of gathering the dispersed cuttings.

### SUMMARY OF THE INVENTION

As will become clear from the following description, the present invention differs from that of U.S. Pat. No. 5,862,595 in at least three very important respects. First, it combines in a single apparatus the additional function of leaf blowing. Second, it adds an enclosure about the rotating trimmer head to reduce the propensity for grass cuttings to disperse outwardly because of the high rotation speeds of the filament lines. And, third, the trimmer head of the invention is recessed upwardly into its elongated housing several inches so that the grass is first sucked up by the vacuuming before it is cut. Such restrictions are particularly useful in the employment of the apparatus as a grass or weed trimmer in the area of in-ground swimming pools. Experience has shown that when trimming around the pool, the grass clippings tend to fly into the pool due to an insufficient vacuuming capability of the design. This is even more so where the gardening tool is of the more general configuration, without the vacuum feature combined with the trimmer.

### BRIEF DESCRIPTION OF THE DRAWINGS

These and other features of the present invention will be more clearly understood from a consideration of the following description, taken in connection with the single figure of the drawing, in which:

FIG. 1 is an illustration helpful in an understanding of the combined weed whacker, blower and vacuum apparatus of the invention as it would be used for trimming and vacuuming operations; and

FIGS. 2a-2c illustrate how the combined apparatus would be used for a blowing operation.

### DETAILED DESCRIPTION OF THE INVENTION

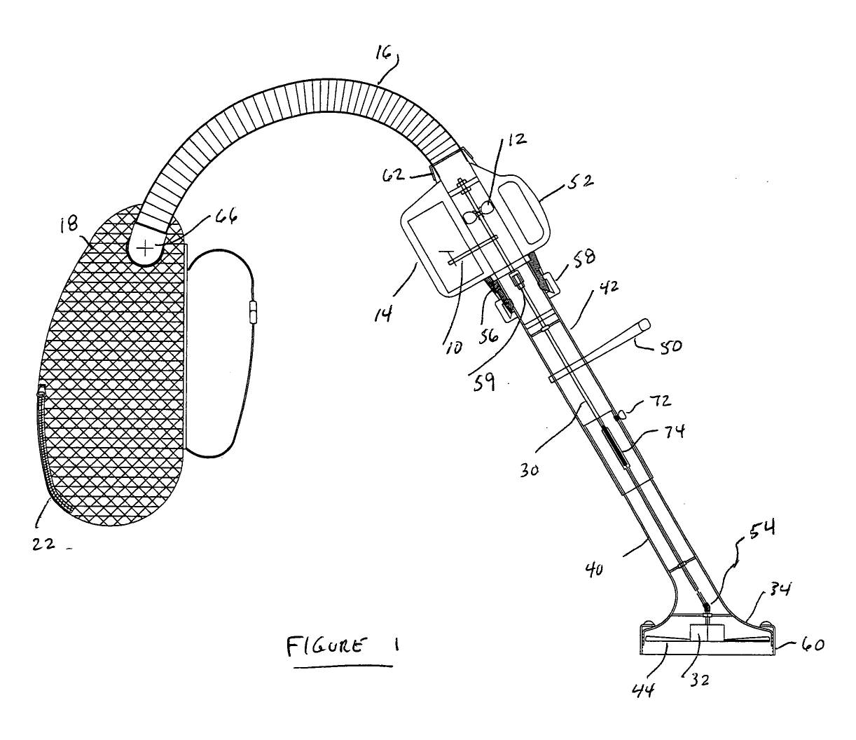

In the FIG. 1 apparatus, the blower and vacuum fan motor unit 10, mulching blade or impeller 12, and operating components are enclosed within a housing 14. The housing 14 is, in turn, connected by an accordion hose 16 to a catcher bag 18 openable by a zipper or like closure 22 for disposing of collected leaves or grass clippings sucked up by vacuum action. An edger rod or shaft 30, joined with a trimmer head 32, couples through the mulching blade 12 to join with the motor unit 10 for rotation in clipping the grass or weeds in places where it is difficult to mow. A second housing or enclosure 34 surrounds the trimmer head 32 to prevent outward dispersal of the clippings to the surrounding area, and restricts the flying of the clippings in any direction other than “up” or “down”. A pair of nested tubes 40, 42 surround the rod 30 in coupling to the housing 14, and are grasped by the user via a handle 50 on the tube 42. A second handle 52 on the housing 14 is similarly grasped, and includes the on-off switch for a battery operated hand held unit. (As will be appreciated by those skilled in the art, similar controls for a gas-powered unit or an electric-powered unit could be located adjacent the handle 52, as well.)

As FIG. 1 illustrates, the enclosure 34 with the trimmer head 32 can be removed by an easy twist-action of a flexible coupler 54. The nested tubes 40 and 42 can likewise be twist-removed from the housing 14 to allow for the easy changing of a filament line 44 from off the trimmer head 32 as needed, as by a release 56 and release ring 58. Similarly, the edger rod 30 could be disconnected from the fan by a coupler 59 with the tubes 40, 42 connected to the housing 14, and with the enclosure 34 and trimmer head 32 removed, the apparatus can operate as a leaf vacuum.

As will be recognized by the skilled artisan, when trimming is to be done, the vacuum control of the apparatus is set the same way, and the enclosure 34 and trimmer head 32 are reconnected. Such action draws the grass, leaves or weeds up towards the filament line 44, sucking them up, but with the enclosure 34 limiting any tendency for their cuttings to fly about to contaminate an in-ground pool or patio area—where they would then have to be later vacuumed away. To further limit any such tendency for the cut grass, leaves or weeds to fall and then be scattered about, the filament line 44, according to the invention, is recessed upwardly within the enclosure 34—preferably some 2-3 inches. This vacuuming of the grass, leaves or weeds up into the enclosure 34 in this manner substantially avoids any clippings or debris from escaping the collection process within the catcher bag 18. Reference numeral 60, in this respect, represents a shroud, adjustable in position to vary the depth of cut of the grass, leaves or weeds, but with the filament line 44 (or like cutting blade), still upwardly recessed within the enclosure 34.

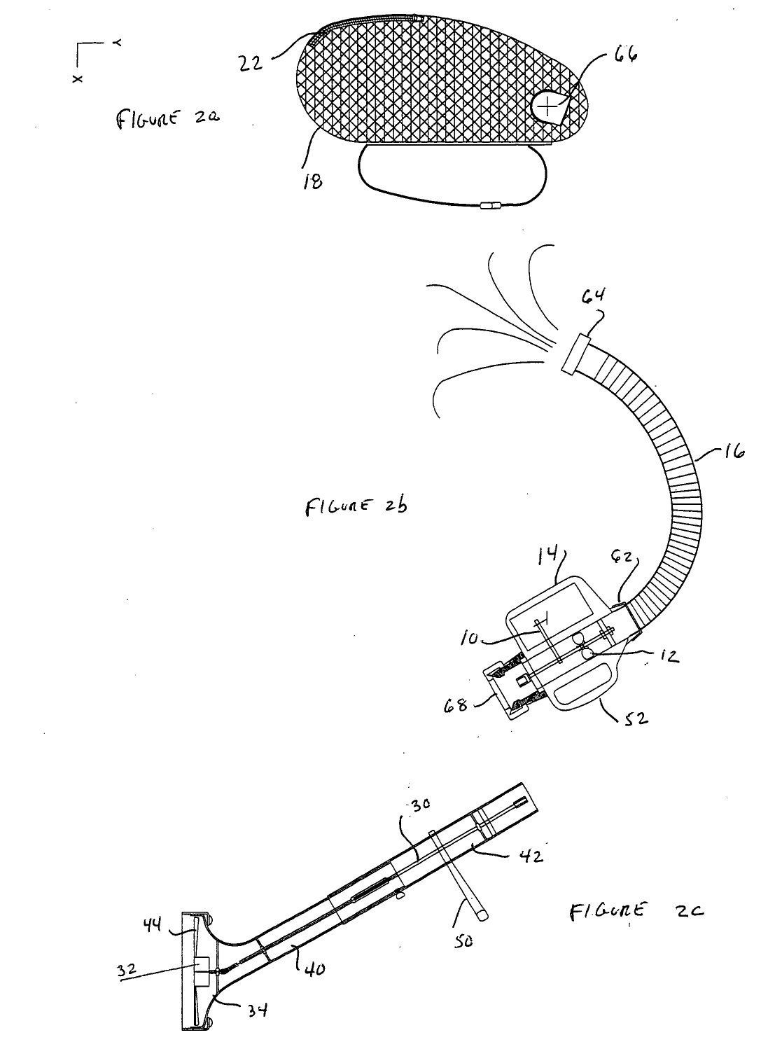

FIGS. 1 and 2b show a quick connect-disconnect 62 for joining one end of the accordion hose 16 with the operating components housing 14. FIG. 2b also shows a second quick-connect-disconnect 64 at the opposite end of the hose 16, which is fitted into a slot opening 66 in the catcher bag 18 when the fan control switch is set for trimming and vacuuming (as in FIG. 1). For use as a blower, the fan is reversed, the connect-disconnect 64 is removed from the slot opening 66, and the accordion hose 16 is selected of a sturdiness to be grasped adjacent to its freed-up end to utilize the air flow to blow away leaf and cut grass/weed accumulation. FIG. 2a shows the separated bag 18 at this time, while FIG. 2c illustrates the disconnect of the nested tubes 40, 42 and the edger rod 30. A screen door 68 protects against a user accidentally sticking fingers into the housing 14 while the blowing operation is going on.

In essence, then, the apparatus of the invention includes the housing 14, which has a first end and an opposite second end to which the accordion hose and catcher bag are connected when the apparatus is being used for trimming or vacuuming—or which can be disconnected when the apparatus of the invention is to be used for blowing simply by reversing an apparatus switch on the housing 14, disengaging the hose 16 from the catcher bag 18 and using the disengaged hose 16 for the blowing. The housing then has a defining first end, with a passage extending between that end opening and the opposed second end. A drive motor mounted with the housing will be understood to be in communication with the passage for actuating the impeller mulching blade. As will be appreciated by the skilled artisan, the operating components within the housing 14 couple to the drive motor to produce the appropriate rotation of the mulching blade during the trimming and vacuuming operations.

The nested tubes 40, 42 encircle the drive shaft 30 and are hollowed to allow air flow upwardly, in allowing the trimming action or vacuuming action to proceed. The lower nested tube shows the second housing enclosing the trimmer head for directing any cut grass, leaves or weeds to fall beneath the head, in preventing it from flying about into an adjacent swimming pool, or other areas where it is desired to keep clear of any debris. As will be apparent, by first sucking up the grass, leaves or weeds before they are cut, any tendency for them to fall beneath the head once they are trimmed is limited to begin with. Reference numeral 72, in this regard, represents an adjustment screw for joining with an adjustment spline 74 of any appropriate manner to vary the overall lengths of the tubes 40, 42 when nested together—as a height/length adjustment for a user to feel comfortable with in holding the combined device when trimming or vacuuming.

While there have been described what are considered to be preferred embodiments of the present invention, it will be readily appreciated by those skilled in the art that modifications can be made without departing from the scope of the teachings herein of being able to remove the trimmer edger unit of the apparatus, allowing the invention to be employed as a vacuuming mulcher with the collecting bag capturing any outside leaves or debris being sucked up, or as a blower by reversing the fan control and disconnecting the accordion hose from the collector bag so as to be able to clear leaves or debris from any specific area. With the trimmer head connected, on the other hand, in the cutting mode of the invention, with the grass, leaves or weeds being first sucked up, then cut, and then mulched, the collection bag will tend to fill up less quickly, resulting in a need for disconnecting the bag from the housing to empty it less frequently, enhancing its manner of use. For at least such reasons, therefore, resort should be had to the claims appended hereto for a true understanding of the scope of the invention.

We claim:

1. A combined trimmer, blower and vacuum apparatus for use with grass or leaves, comprising:
a first housing having a first end, an opposed second end, and a passage extending therebetween;
a drive motor and fan blade mounted with said first housing in communication with said passage;
a mulching blade mounted within said first housing;
a trimmer head assembly for cutting grass;
a drive shaft between said drive motor and said trimmer head assembly;
first means within said first housing coupled to said drive motor to rotate said fan and mulching blades in a first direction to cause air to flow upwardly through said passage from said first housing end to said second housing end;
a hose connected at a first end to said second housing end such that air flowing through said passage flows through said hose;
a collecting bag coupled to a second end of said hose for capturing cut grass or leaves;
a first tube surrounding said drive shaft;
a second housing enclosing said trimmer head assembly at a first end of said first tube;
a second tube surrounding said drive shaft having a first end coupled with said first housing end and having a second end coupled with a second end of said first tube; and
with said trimmer head assembly being recessed upwardly within said second housing an amount to be substantially wholly enclosed therein;
whereby only a limited amount of grass or leaves falls to the ground below said trimming head assembly when cut.

2. The apparatus of claim 1 wherein said trimmer head assembly is recessed upwardly some 2-3 inches within said second housing.

3. The apparatus of claim 1, including second means for disconnecting said trimmer head assembly from said drive motor when only vacuuming cut grass or leaf accumulations.

4. The apparatus of claim 1, wherein said first means is also coupled to said drive motor to rotate said fan and mulching blades in a second direction to cause air to flow downwardly through said passage from the second housing end to said first housing end, and including third means for disconnecting said hose when only blowing away cut grass or leaf accumulations.

5. The apparatus of claim 1, including a graspable handle on said first housing and a graspable handle on said second tube.

6. The apparatus of claim 1, including second means to adjustably control the length of said first and second tubes when coupled together.

7. The apparatus of claim 1, including means to adjust the height of said second housing above the ground.

8. The apparatus of claim 1, including means to adjustably control the length of said first and second tubes when coupled together, and means to adjust the height of said second housing above the ground.

9. A combined trimmer, blower and vacuum apparatus for use with grass and leaves, comprising:
a first housing having a first end, an opposed second end, and a passage extending therebetween;
a drive motor and fan blade mounted with said first housing in communication with said passage;
a mulching blade mounted within said first housing;
a connectable trimmer head assembly for cutting grass;
a drive shaft between said drive motor and said trimmer head assembly when connected;
means within said first housing coupled to said drive motor to rotate said fan and mulching blades in a first direction to cause air to flow upwardly through said passage from said first housing end to said second housing end when in a first position, and to rotate said fan and mulching blades in a second direction to cause air to flow downwardly through said passage from said second housing end to said first housing end when in a second position;
a hose connectable at a first end to said second housing end;
a collecting bag coupled to a second end of said hose;
a first tube surrounding said drive shaft;
a second housing enclosing said trimmer head assembly at a first end of said first tube when said trimmer head assembly is connected;
a second tube surrounding said drive shaft having a first end coupled with said first housing end and having a second end coupled with a second end of said first tube;
with said trimmer head assembly being recessed upwardly within said second housing an amount to be substantially wholly enclosed therein when connected with said means rotating said fan and mulching blades in said first direction, and with said trimmer head assembly being disconnected when said hose is connected to said second housing end when said means rotates said fan and mulching blades in said second direction.
